(19) United States
(12) Patent Application Publication
(10) Pub. No.: US 2019/0303583 A1
(43) Pub. Date: Oct. 3, 2019

(54) CYBER SECURITY SYSTEM AND METHOD

(71) Applicant: Jophiel Pty. Ltd., Moonee Ponds ,VIC (AU)

(72) Inventors: Graeme Hosking, Kew, Victoria (AU); Christrina Tutone, Kew, Victoria (AU)

(73) Assignee: Jophiel Pty. Ltd., Moonee Ponds, VIC (AU)

(21) Appl. No.: 16/307,616

(22) PCT Filed: Jun. 7, 2017
(86) PCT No.: PCT/AU2017/050567

§ 371 Date: Dec. 6, 2018

Related U.S. Application Data
(60) Provisional application No. 62/346,938, filed on Jun. 7, 2016.

(51) Int. Cl. G06F 21/57; G09B 7/02; G09B 5/06; G06Q 10/06; G06Q 50/20

(52) U.S. Cl. CPC G06F 21/577; G09B 7/02; G06Q 50/20; G06Q 10/0639; G09B 5/06

(57) ABSTRACT

An apparatus and method of using gamification and human behavioral analysis to quantify cyber security risks for a corporate or individual entity, in which the apparatus, or systems, can include a comprehensive real-time cyber security risk assessment, monitoring and remediation service, particularly through quantifying the qualitative aspects of individual user behavior and entity-level cyber security activities, and incentivizing and enabling effective cyber security outcomes through gamification. These capabilities will also enable the apparatus, or system, to deliver real-time cyber insurance to users on a risk-effective basis.

### FIELD OF THE INVENTION

The present invention provides for systems and methods for the implementation of a cyber security behavioural system, and, in particular, discloses a system and approach for creation of systems, software applications and computer implemented methods for gathering machine learnings and gamification data across all business systems to quantify cyber security risks and identify remediation required within any business or user environment on a real-time basis.

### BACKGROUND OF THE INVENTION

Any discussion of the background art throughout the specification should in no way be considered as an admission that such art is widely known or forms part of common general knowledge in the field.

With the increasing levels of corporate dependence on Information Technology (IT) systems and their ubiquitous interconnection into an Internet type environment, there has become an increasingly bewildering range of malicious attacks by hackers or the like, operating in the ‘cyber space’, to attack or undermine the operations of corporate individuals.

The attacks can take many forms, but normally target vulnerabilities in IT systems, to steal confidential, commercially sensitive information or provide for denial of services and other malicious activity. Additionally, the attacks can target individual employees through sophisticated social engineering.

With the increasing complexity of the attacks, there is the difficulty at large in identifying an organization's and individual's readiness to deal with attacks. This leads to substantial downstream problems, in third parties, such as insurance companies or the like, trying to identify a corporation's and individual's readiness for dealing with cyber attacks. Further, currently there is no underwriting process that utilises a real time security behaviour metric to measure individual behaviour and how it impacts cyber security.

Business environments can consist of multiple systems which includes methods and procedures to perform daily operations of a business. A system can relate to a detailed set of methods, procedures and routines created to carry out a specific activity, duty or to solve a problem. These combined form various systems within all businesses. An example is network infrastructure to run a business, computer systems which manage software within the business, procedures to manage behaviour related to the business operations, policies to place boundaries within a business and where applicable to enforce legislation practices. Data privacy management to comply with privacy laws and client security requires many systems within the business environment to be effectively operated at all times.

Cyber security threats impact the entire business infrastructure not only the technology aspects of a business. Various methods are now used to infiltrate a business, such as social engineering, strategic phishing campaigns targeting individuals of company business practices and targeted human behaviour monitoring by external human agents.

To provide a significant security infrastructure the entire business environment requires systematic management. From the people to the various systems/methods within the business and this is required on an ongoing basis to provide effective security.

A business system can be dedicated to a specific aspect of the business such as network infrastructure, privacy principles and legislation. It is currently expected that an individual in a business understands the systems and practices and uses this information or leanings in their day to day actions of the business. There are many variables that a human cannot predict or compute when having to access all the systems to secure the environment whilst they undertake their daily job. This security risk has increased over time with strategic social engineering attacks taking place aimed at the individual's weaknesses within a business environment.

### SUMMARY OF THE INVENTION

It is an object of the invention, in its preferred form to provide for systems and methods for the production of an objective and comprehensive real-time cyber security risk assessment, monitoring and remediation service, in particular through quantifying the qualitative aspects of individual user behaviour and entity-level cyber security activities, and incentivising and enabling effective cyber security outcomes through gamification. These capabilities will also enable the system to deliver real-time cyber insurance to users on a risk-effective basis.

To manage security and increase cyber awareness and minimise risk to a business environment a business can employ a cyber security behaviour system to drive human behaviour to operate and place controls within the business environment to secure all systems. The embodiment provides for a computer system to manage all systems within the business environment and then employs gamification techniques from within an application to engage individual users to learn, understand and implement specific actions to deliver an effective cyber security and privacy environment.

The embodiments include involves systems, software applications and computer implemented methods for gathering data, providing machine learning and gamification data across all business systems within any business environment on a real-time basis.

One innovative aspect of the embodiment is the cyber security behaviour system implements a computer implemented method by determining and amalgamating all the system requirements of a business environment into an application which can be accessed via a computer based interface, including an IOS application or Android or equivalent. These combine external best practices locally and globally across all the business systems (network infrastructure frameworks, infrastructure, legislations) established within the Cyber Security Behaviour (CSB) system which call on data systems which combine machine learnings to predict best practices in an individual business environment.

Another innovative aspect of the present invention, is the provision of a method of creating a cyber attack risk index for a corporate entity, the method including the steps of: defining a set of corporate risk issues indicative of a cyber risk; for each of said corporate risk issues, determining an individual corporate risk value of the degree of risk a corporate entity suffers from the corporate risk issues, and further defining an impact score of the corporate risk issue eventuation would have on the corporate entity; and further deriving a corporate risk issue weighted score from the corporate risk value and the impact score; and combining the weighted scores to derive an overall cyber attack risk index.

In a further aspect of the invention, there is provided a method of improving the cyber security environment of an organization, the method including the steps of: (a) providing a gamification system based around the cyber security of environment of an organisation, the gamification system directed at monitoring an individuals human behaviour in cyber connected activities; and (b) providing an incentive under the gamification system directed to improving human behaviour in the cyber security environment.

### BRIEF DESCRIPTION OF THE DRAWINGS

Embodiments of the invention will now be described, by way of example only, with reference to the accompanying drawings in which:

FIG. 1 illustrates the operational environment;

FIG. 2 illustrates schematically the cyber security behaviour (CSB) system;

FIG. 3 illustrates the various domains of gamification of a user's environment;

FIG. 4 illustrates the process of creating an initial scoring flow;

FIG. 5 and FIG. 6 illustrate example app views of the gamification user interface;

FIG. 7 illustrates schematically the dynamic insurance risk management process;

FIG. 8 illustrates the process of logging breaches;

FIG. 9 is a schematic block diagram of one form of an overall architecture for operation of a Cyber scoring system;

FIG. 10 illustrates a more complex alternative Cyber score monitoring and calculation system;

FIG. 11 illustrates an infrastructure arrangement for the creation of an alternative embodiment;

FIG. 12 illustrates the factors utilised in measuring an individual's behaviour;

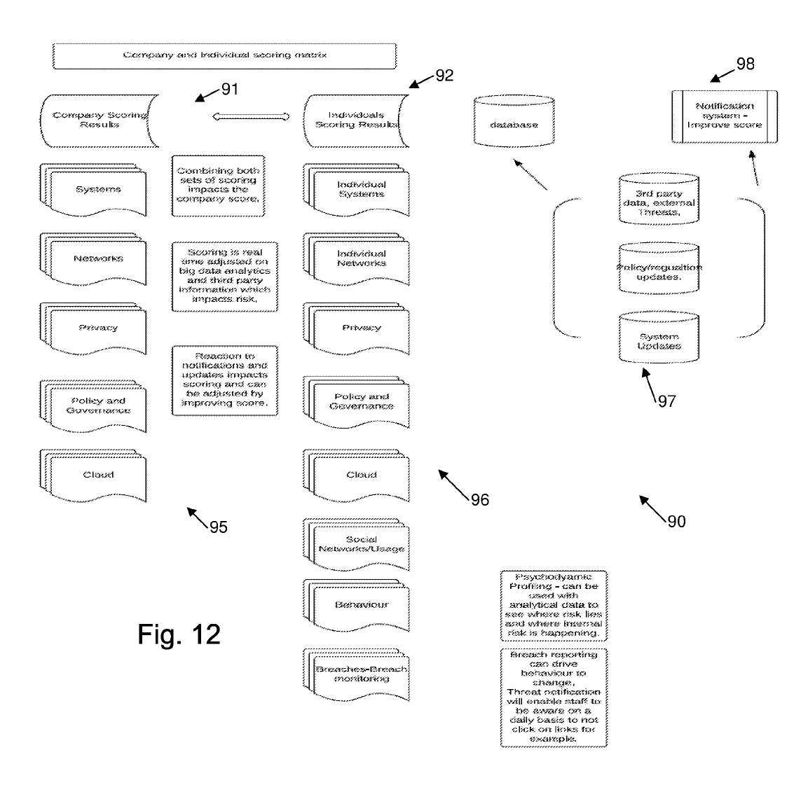

### DETAILED DESCRIPTION

The described system embodies a number of elements which address both the system and the human elements of cyber security. The system uses a flexible real-time user app for ease of use; The system assesses and monitors the business environment on a continual real time basis, based on monitoring appropriate technology use, adherence to policies and procedures as well as monitoring of the human element of cyber threat and risk; The system leverages internal and external risk analysis to identify the most cost and effort-effective methods to secure a business against cyber attacks; The system deploys gamification principles to prioritize, manage and implement cyber security policy and procedures; and motivates, rewards and incentivizes users to adopt the behaviors, policies, controls and systems-usage needed to secure the business against cyber attack.

The system provides a real time cyber behavioral system for the user, together with specific real-time actions identified to mitigate or remove these risks, and ongoing monitoring of the user to ensure effective implementation of these corrective actions.

Starting with a self-identified score, system algorithms determine a profile and relative cyber risk benchmark for the user (based on psychology methods and analysis tools including predictive analytics and machine learning). This self-identified score is then combined with further inputs into the system scoring platform to establish a valid assessment of the user's current state within the entire environment. Actions are then proposed based on any weaknesses (identified by the system), prioritized and time-boxed to minimize cyber risk with the least initial effort by the user. Gamification principles (notifications, peer rankings, score changes) are deployed to incentivize user action.

As users improve their performance through implementing the action and policies proposed, the system adjusts (through gamification) the actions needed, and “rewards” provided. This also enables company directors to understand their staff at an individual level on how they behave in many aspects of the business, such as policy, procedures and training requirements to minimise general (not just cyber) risk and adherence to compliance requirements.

Various gamification systems are known. For example U.S. Pat. Nos. 8,768,751, and 9,623,333 disclose gamification systems, as does US patent publications 20130337909 and 20130171593.

Interaction Between Environment and User Scores

The CSB system recognises the impact of environmental features and changes in the relative security of every business and user. The system utilises both internal input and external servers and data to assess and score the business environment as well as the individual business user. The system can also make changes in real time to best practice policies within the system. For example: when the government changes a privacy law this can be distributed within the CSB platform to all users, trigger a change to the business score, and enforce businesses to undertake actions such as changing procedures to match policy. Gamification systems can be triggered for each individual user assigned to a company, to undertake the actions, verify the actions are undertaken, and adjust the scoring algorithm accordingly.

Each individual staff member's score also impacts an overall company entity score in real time as the behaviours of the individuals contribute to the businesses overall security. If an individual fails to adhere to policies or procedures (with all variables targeted within the gamification system) this will impact the company entity score as well as the individual's score. If a business fails to establish best practices in accordance with specific legislations or laws such as privacy laws this will impact the company entity score and also trigger the CSB gamification engine to generate the applicable notifications to improve the business systems to regain ranking within the system. This may also trigger changes within the application to create a series of new actions (gaming tasks) which can be sent to the entire user base to action.

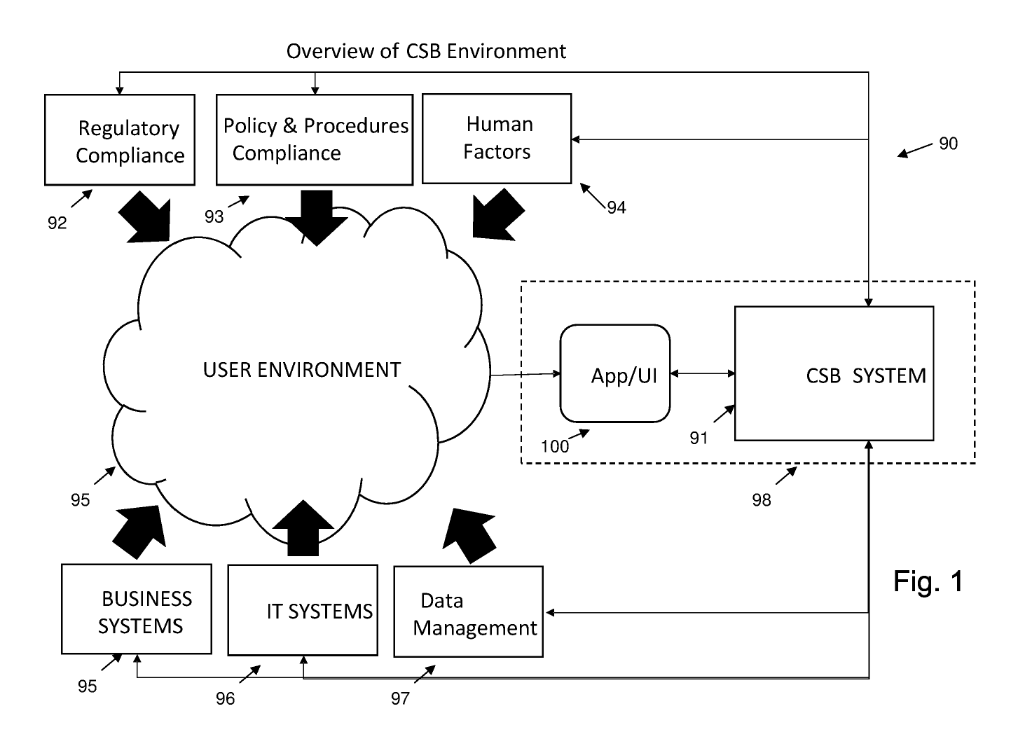

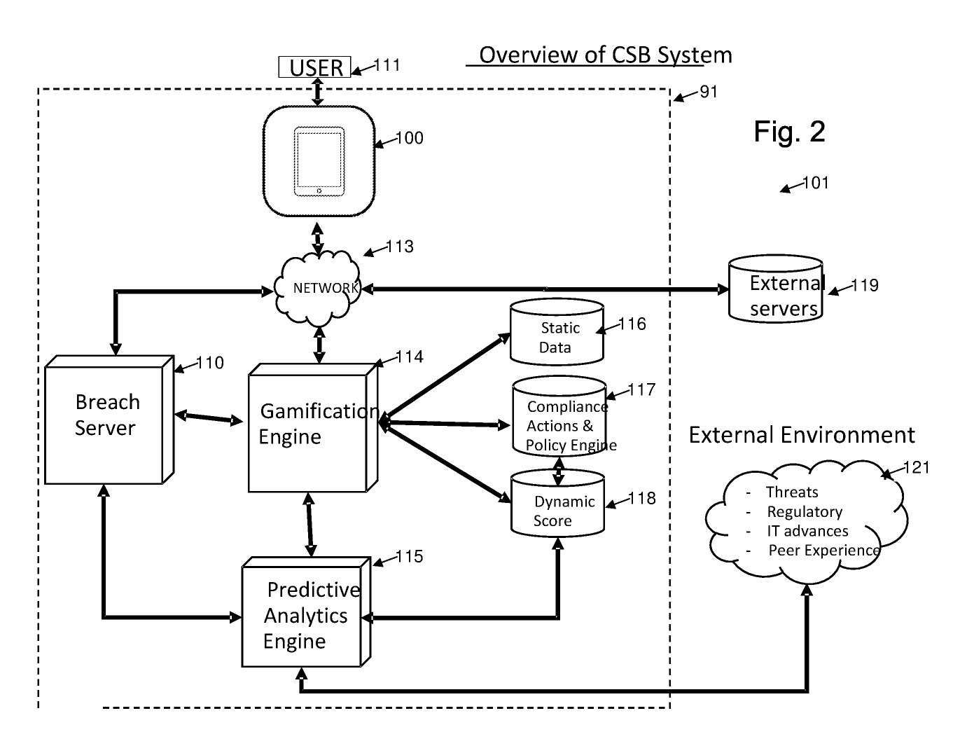

Human Behaviour Logic (FIG. 1, FIG. 2)

FIG. 1 illustrates the operational environment of the CSB system and provides a high level view of the wider cyber security and data privacy environment in which users need to operate, illustrating the CSB System 91 operates beyond a machine-to-machine only tool. The CSB System takes account of the user experience of, and actions in, each of the different domains e.g. 92-97 for cyber security and data privacy considerations.

The CSB System 91 recognises that every human is an individual, who may respond differently to other humans in any one scenario. The system drives the behaviour of each staff member (user) to achieve better cyber security outcomes through utilising human psychology principles within the logic of the application (behaviour types, patterns of behaviour, style and motivational drivers) and through analysing the external variables in the business environment (Example: Industry, technology used, legislations, policies, compliance requirements, etc. 92-97).

The system deploys machine learning to discover and analyse patterns buried within user behaviour, system performance, and also external input into the system algorithm, such as current threats, risks and other data not limited to internal monitoring systems. This analysis enables the system to continuously enhance gamification logic to ensure user and business adoption of cyber security controls and policies in real time.

Feedback to users is provided through system reporting centres within the user interface or app 100, which will show users actions to take, users scores and motivational elements such as rankings against other staff or comparable businesses. Industry best practice will highlight companies which are high ranking and motivate companies to establish best practice, which the system will distribute as learnings and actions suggested for user implementation.

FIG. 2 illustrates an overview of the CSB System. The system supports a range of users 111. It can be used in small medium and large enterprises and public entities), but it also encompasses individual users (as members of staff for enterprises who contribute to its cyber security baseline), individual users (in their own right), company clients (who can provide security insights on their SME suppliers), and school users (teachers and their pupils), who will use the service for educational as well as practical cyber security management purposes.

The App/User Interface 100 provides users with the ability to access the system through an app, based on popular standards such as, but not limited to, IOS, Android, Windows, Web (Java). The app prompts the user to complete the necessary steps, using computer systems and data processing applications relevant to third parties and internal systems via the Gamification Engine 114 as needed to validate information provided. The app also presents results from the system, notifications (for user action), and external cyber threat status. The app also permits real time cyber incident and breach reporting, and analysis of the outcomes of the breach.

Network 113: The App/UI accesses the core CSB system via networks such as the internet, intranet secured through industry standard encryption protocols.

Gamification Engine (GE) 114: The system deploys gamification principles to ensure continual improvement through the Gamification Engine (GE), which effectively monitors and incentivises implementation of corrective actions by the user via the compliance actions & policy engine CAPE 117. This is achieved through the means of user incentives (“rewards for winners”) to complete the assessment, to learn cyber security requirements, and to take ongoing actions to operate all user systems and processes appropriate to minimise cyber threats wherever possible. The system will also use notifications to users to encourage action (e.g. “someone in your industry just got breached—check you have completed all outstanding security fixes”). The GE also updates the score via the dynamic score manager (DSM) 118 to ensure user scores are adjusted to reflect compliance with expected corrective actions.

Predictive Analytics Server (PAS) 115: The PAS provides statistically relevant assessment of cyber risk presented by the user via the DSM, and then updates this on a real-time basis through dynamic sampling of the external environment and internal (user) state of cyber-security readiness, as evidenced through the breach and incident reporting service 110. The PAS establishes the causality of cyber incidents and most effective corrective actions or controls to protect users from future cyber risk. These risk weightings are updated dynamically to ensure the score is based on latest information from internal and external sources. The PAS also profiles user behaviour over time and uses this information to adjust score weightings via the DSM and corrective actions or preventative controls via the Compliance Actions & Policy Engine 117.

Static Data Module (SDM) 116: The enterprise user records a range of information about their business (industry type, size, employee numbers)—which are factored into the cyber risk analysis via the GE 114 and used to ensure relevance of the score findings 118. These data elements are kept securely separate from the other system data, and held under 2 factor authentication with the user for privacy reasons.

Compliance Actions & Policy Engine (CAPE) 117: Once the user has completed their score 118, the system will identify in real time the needed user actions to reduce their cyber risk and therefore improve their score. Through gamification principles these actions will be prioritised and incentivised for user action, and then presented back to the user via the GE 114 into the app 100 alongside the score baseline report provided 118. These user actions to remediate security weaknesses take account of external regulatory and general cyber-criminal activity 121, as well as actual incident and breach reports, captured by the system and third parties 110. Companies may also wish to generate policies in real time which embed cyber security and data privacy best practice, for adoption by their staff, production of which can be automated through CAPE.

Most small businesses do not have policies which embed cyber security and data privacy best practice. The system maintains internal policy components via the Compliance Action & Policy Engine (CAPE), which supports cyber security best practice, and which can be provided to the user in real-time for implementation within their business to improve their score and address security weaknesses. Businesses can design their own policies based around this capability, along with the relevant rewards and incentives both long and short term (system scoring module and algorithm) specific to a business and managed by the business owner. These business-specific rules can then be added into the gamification system, to encourage policy adoption by users, and behaviours monitored real-time through the system to ensure policy compliance, which is then fed back into the dynamic score.

Dynamic Score Module (DSM) 118: The DSM serves up specific questions depending on the nature of the user as identified by the static data module to ensure questions are relevant to the user but not over-whelming in number. Answers are fed back through the DSM to establish a baseline score, with answers analysed by the GE to identify priorities for user actions and present these actions using gamification principles to ensure effective adoption by the user. Adoption of actions within certain timescales will have an impact on the score (hence it will be dynamic), as will external events and actual breach and incident events.

External Servers 119: The system can deliver services to users which are provided by third party servers using computer systems and data processing applications through networks such as the internet, and embedded in the app (2) seamlessly to the user. These include services such as automatic validation of user data.

Breach & Incident Server (BIS) 110: Users are able to capture incident (potential cyber-crime events, such as suspect phishing emails) and breach (actual events where loss or business impact has occurred) through the app which sends a breach log report to the BIS. The BIS analyses events by user type (e.g. industry, size) based on SDM data 116. Where appropriate breach responses are broadcast direct back to the user, as well as general alerts to other CSB system users. Follow-up changes to remedial action needed to prevent future breaches are analysed through the PAS 115 and then incorporated into the DSM 118 and CAPE 117.

External Environment 121: The PAS 115 regularly assesses the external cyber threat environment, as well as regulatory changes and changes to technology (impacting cyber security), and these changes are assessed and then updates provided as needed to the DSM 118 and CAPE 119.

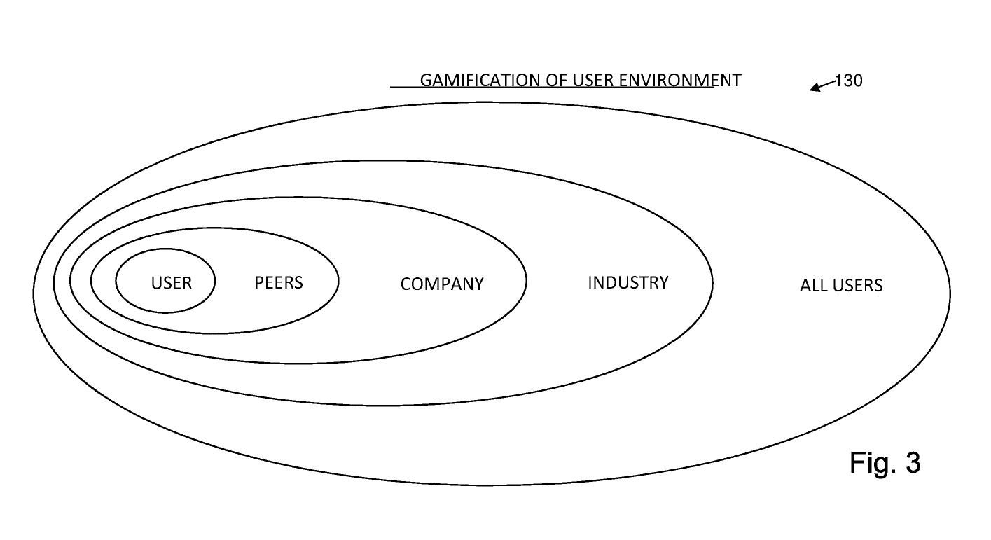

FIG. 3 illustrates the Gamification of the User Environment and represents the nested nature of users. Gamification can occur at each level, starting with the individual user, getting their score on an individual basis. Gamification will incentivise the user to improve their performance. Extending the gamification to other users (peers) will increase the motivation and learnings, and each level of extension will add further benefits to the user.

The system can enable users to score not just themselves but also to incorporate scoring information from external users, and to compare performance against that wider universe of users, incorporating external users into the system's gamification logic. For example, an individual can score themselves, and also compare their performance against their peers within the company, or against a wider universe of all individual users. Businesses can compare themselves against other company performance within their industry, or against all companies. These escalating levels of gamification enable users to leverage best practice and drive continuous improvement in their levels of cyber security and data privacy, whatever their current state.

The system's ability to include outside input in user scores further enriches the quality of the score. For example, clients of a company can use the system to rate a business on its policies and procedures. Where a company has opened the system for external review and scoring, the company may set various behavioral actions that staff must do when dealing with clients, such as that all clients must receive a privacy policy on initial dealings.

Adherence to these actions can be displayed through the system UI, and client feedback will validate if this behaviour occurred, with the answer affecting the individual's score accordingly. The system can enable a business owner to monitor behaviours of staff and see relative performance of staff members through this feedback, as well as potentially to enable clients of a business to use the application to see which businesses have the best cyber security scores (where a business decides to publish its score).

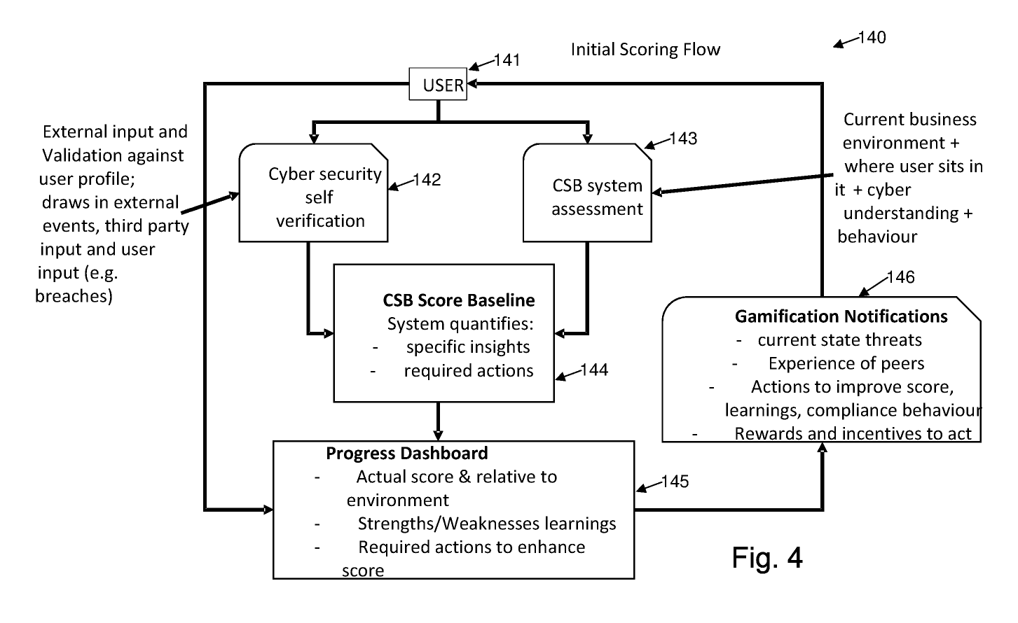

Turning to FIG. 4, there is illustrated the Initial Scoring Flow process 140. A primary user completes the scoring process on behalf of the business entity which is being assessed for cyber security readiness. Secondary users will be staff members nominated by the primary user, who can complete a similar but differentiated question set in order to establish their individual cyber risk profiles and policy compliance, which in turn will feed into the overall business score.

Cyber Security Self Verification 142: The first step in the process is to invite the user to assess their overall cyber security risk rating based on their current understanding of matters. This provides an element of human self-verification of the score, as well as creating motivation to complete the Cyber score in order to confirm the accuracy of the self-assessment. The system draws upon external inputs and events (e.g. recorded breaches, credit scores, social media profile, etc) to provide profile of user.

CSB System Assessment 143: The system takes the user through a set of analytical questions which cover the major areas of cyber security and data privacy risk and the controls needed to mitigate these risks. The system selects user-specific questions based on user profile and answers to prior questions. Answers to these questions are also verified through machine verification of the responses, and establish the business environment in which the user works, their position (role), and their understanding of cyber security and data privacy requirements and best practice.

Cyber Score Baseline 144: This score baseline is a report that summarises a number of important elements for the user, namely: Score level, and related cyber risk assessment, with predictive outcomes indicated; Insights on the key cyber strengths and weaknesses of the user; Prioritised actions to remediate key cyber security weaknesses for the user, arising from the score. The baseline is presented to the user with cases for action (e.g. consequences of inaction).

Progress Dashboard 145: The CSB System provides users and related parties (e.g. company management) with summarised information through dashboards that enable users to understand their relative and absolute performance in cyber security and data privacy terms, to identify areas for improvement, to understand what actions are needed to achieve improvement, and to be provided with best practice learnings to assist in taking these actions.

Gamification Notifications 146: The CSB System provides notifications based on gamification principles to encourage users to improve their performance in, and knowledge of, cyber security and data privacy management. These alert the user to specific actions needed, warn them of imminent or actual cyber threats seen in the broader environment, and provide incentives to act, such as improve performance rankings against peers or others.

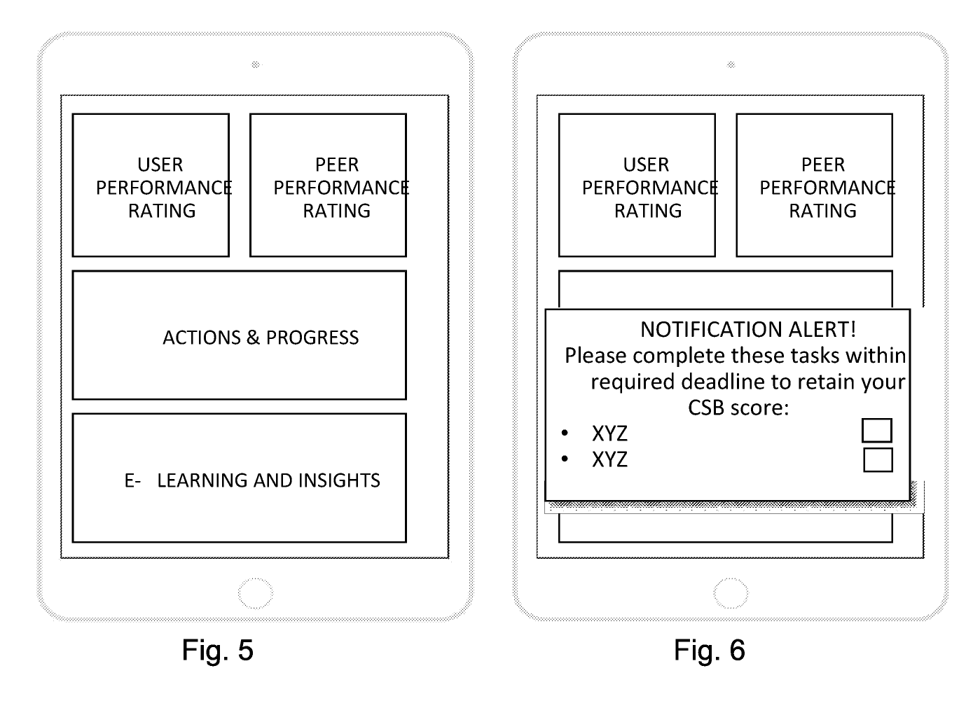

FIG. 5 and FIG. 6 illustrate example App mockup interface views, illustrating the Gamification reporting, including representations of the features provided by the CSB System Progress Dashboard report, including Gamification notification alerts in FIG. 6.

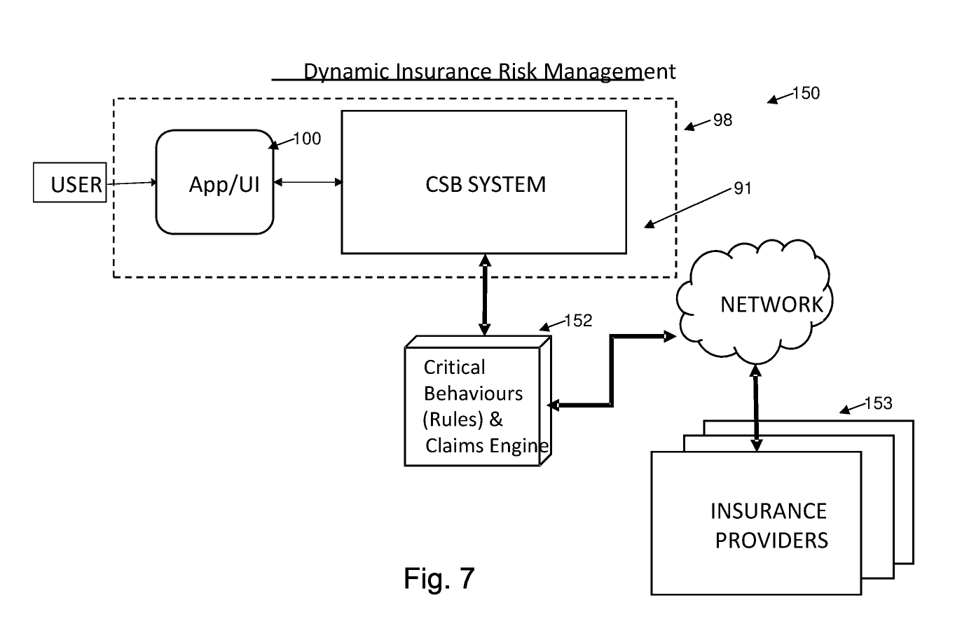

The system can be further used to provide for confirmation of Cyber Insurance. FIG. 7 provides an example of the interaction with insurance providers. The CSB system 91 provides analytical and user-compliance data which enables insurance companies to write cyber security insurance at cost-effective levels, while minimizing premiums paid by businesses.

The system can set certain minimum controls, behaviours and policies (“Rules”) 152 which have to be adhered to by the user in order for the business to remain within the insurance policy cover. Adherence can monitored real time, and if these rules are not complied with the user score therefore drops beneath certain thresholds, following which the user's business cyber insurance policy may not be effective for making a claim. In practice, the business can be notified that a policy breach is imminent with time given within which to remedy the action. The system therefore enables insurance companies to set base line behavior to ensure a policy remains effective, and also provides a real time system which in the event of a user claim can supply historical data to see where user actions may have instigated cyber breaches, thus streamlining and automating cyber insurance investigations and claim handling.

The CSB System 91 provides score information to the CBCE 152 to enable the user to achieve insurance cover based on actual risk of cyber threat to the user, via nominated insurance providers 153. Take-up of insurance can be an option, but if taken up then the CBS System interfaces with the Critical Behaviours & Claims Engine (CBCE, 152) to ensure that the user remains within acceptable limits to ensure the insurance cover is always effective and any valid claim therefore will be paid.

The CBCE 152 is designed to ensure that every user which obtains cyber insurance can be sure that any claim will be met automatically and in full by the policy provider 153. The CBCE maintains minimum expected behaviours by the user (also known as “CBS System Rules”), compliance with which will ensure insurance cover remains valid at all times. User compliance is monitored via the CBS system and generates updated scores which in turn update the CBCE to confirm that the CBS System Rules have been followed at all times.

The CBCE 152 interfaces on behalf of the CBS System user with nominated insurance providers 153 online via a network such as the internet. A panel of insurance providers will provide product disclosure (PDS) and premium information to be transmitted real-time to the system, which will then provide this via the CBCE to the user as an option to mitigate potential future commercial losses should a cyber threat occur.

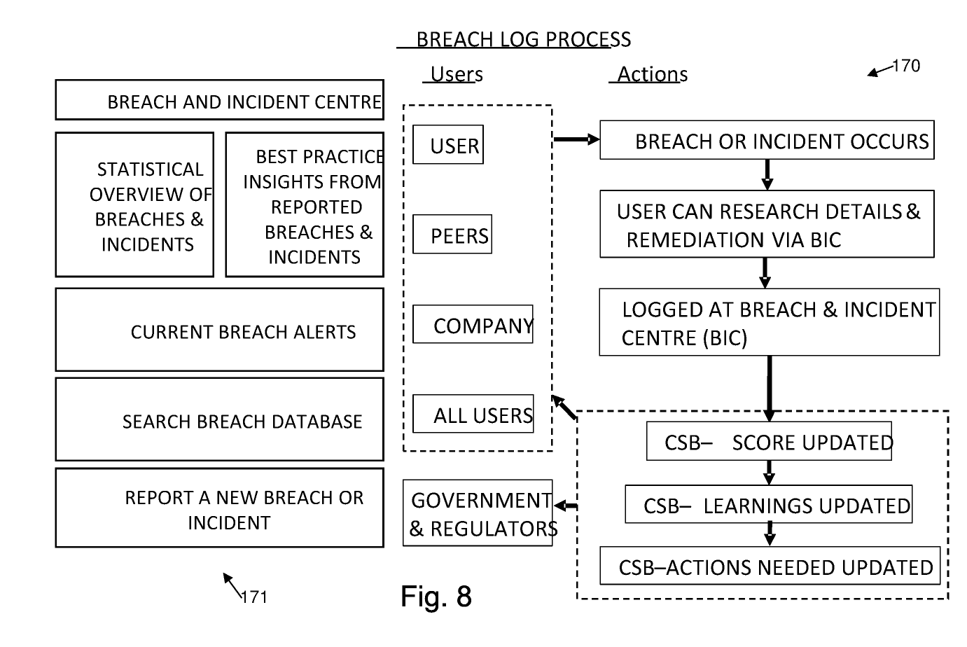

FIG. 8 illustrates the breach log process 170 including example mock up of the app interface 171. Representation of the Breach and Incident Centre (BIC) feature of the CSB System, and simple flowchart showing user actions when breach or incidents occur. Note updates from the system can go to all users, as well as government and regulatory bodies as deemed appropriate.

The system enables users to manage breaches (actual cyber crime) and incidents (suspected or attempted cyber crime) through the Breach Server (110 of FIG. 2), which manages all elements provided to the user through the user interface Breach & Incident Centre (BIC). This system enables users and company owners in real time to see any past and potential cyber risks to their business, and to make changes to behaviours and procedures with the company accordingly. Through the BIC users are able to easily lodge incidents and potential breaches online, and to manage subsequent reporting and analysis of the events. Peers can also input events where they have observed breaches of policy by users, to effectively improve or impact another users score. Reported events are used by the CSB system via machine learning to establish best practice not only within the individual business reporting, but throughout all users within the CSB universe. CSB algorithms will also take account of BIC events to adjust the user and business scores and gamification system actions. The system also gives users access to a knowledge base which can be accessed in the event of an attack, to be directed how to remedy and what corrective actions to take. This can then be verified by another staff member that the user did the actions, the breach was amended and the user will be rated by the peer. The breach will also be rated.

The CSB system can have other uses. For example, the CSB system can also be used for schools to educate children by using gamification to educate pupils on privacy and cyber safety among other things. The system can generate the same individual scoring and the system scoring based on the variables of data specific to an age, group and learnings required. The students can then have their behavior and understanding scored using the same system as for businesses. This will also enable schools to set policies and monitor adherence in an easy and effective way. In this example, the universe of users would include students at other schools, so that students can also rate their performance against each other and other schools. This is an effective way to teach and motivate children on the subjects of cyber safety. The system's machine learning capability will also enable the system be an effective educational tool for cyber security as it is built to run various modules on any topic to be scored.

Further Description of the CSB System and Alternative Embodiments

The further embodiments provide for a system and method which produce a measure of a corporation's or organization's readiness to deal with cyber attacks, so as to provide both an internal and an external measure of a company's abilities and the abilities of its individual employees.

This measure of readiness, hereinafter denoted a ‘Cyber Score’, provides an objective, quantified measure of a corporations resistance to Cyber attack, and provides for a methodology whereby third parties can objectively measure a corporation cyber attack readiness.

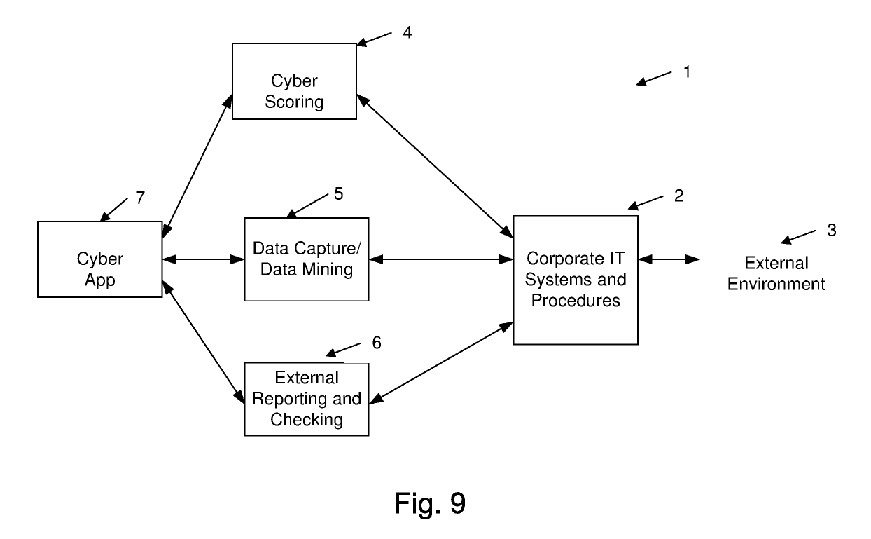

FIG. 9 illustrates one form of an embodiment 1 of the invention where a number of cooperating units within the CSB combine to provide an overall Cyber Score.

The embodiment is designed to run across a corporate IT environment and their procedures 2 in monitoring their responses to an external environment 3 which may contain threats or the like. The system 1 includes three components, including cyber scoring component 4, data capture and mining component 5 and external reporting and checking component 6. These components can be operated under the control of a user interface application, denoted the Cyber app 7, that can run in many different environments, including as a stand alone mobile web based app, or in a browser application.

The embodiments are provided to monitor an overall cyber security risk of the IT assets of an organization.

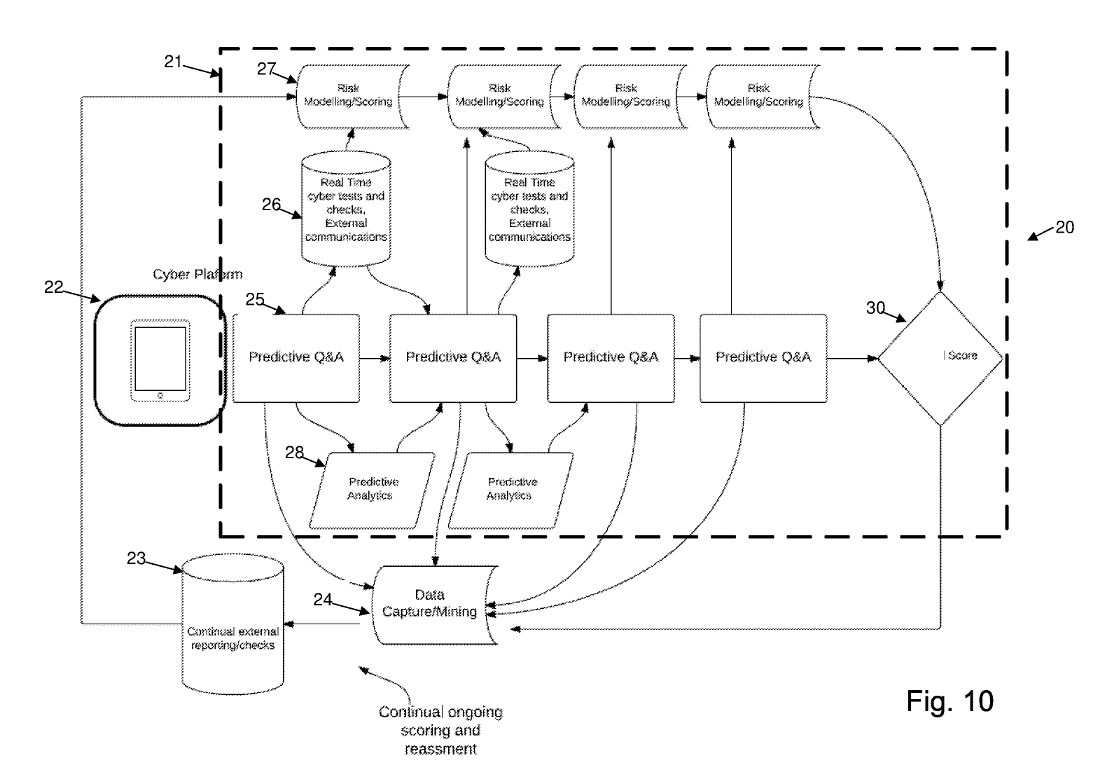

Turning now to FIG. 10, this illustrates in more detail an alternative form of the implementation of an embodiment 20. In this arrangement, the CSB scoring system 21 involves a much more complex interaction under the control of the CSB system 22. The components 24 performs continual external reporting and checks and the component 24 collects data on the organization for data mining purposes. The CSB scoring system 21, in this embodiment, is made up of a number of more complex components, and includes a series of predictive analytics forming complex tests on the company. The tests e.g. 28 are used in conjunction with question and answer sessions e.g. 25 to provide output results that are collated as part of a Cyber score 30. Further risk modelling units e.g. 27 that analysed potential risk factors and are again combined with a Cyber score unit 30.

The Cardinal Cyber score has a number of uses, including the use by small to medium businesses to address the issue of cyber threats and attacks. Currently the cost for SME's prohibits them from undertaking a comprehensive assessment. This cyber score system provides an automated assessment which can be individually utilized or provide by a third party such as an insurance broker. The Cardinal Cyber scoring system utilises comprehensive predictive/intelligent cyber auditing, which can predict question sets and utilise external data, big data and algorithms to provide a risk report in real time.

The audit application is available for a small to medium business and includes an external vulnerability scanning tool. The application can also be scaled according to the company size and requirements.

Scalability: Where there is a greater number of systems/users (such as PCs and staff), the Cyber assessment can be used by each staff member and across a whole organization. This will provide an individual staff score, which is then fed into the CSB cyber scoring platform to provide a scalable score for the company. Utilising the same technologies, such as breach reporting and patch notification, the enterprise system allows a company to track at the individual user level, their interaction with the CSB system and monitor their scoring and activity.

For example, where a staff member does not sign off on all policies within the CSB system, this affects the corporation's overall scoring. In a second example, where a staff member has not updated any patches or system updates in months, this again contributes to a low value CSB cyber score.

Returning to the arrangement of FIG. 9, the CSB platform provides this information to users via an overall reporting facility in the CSB Cyber App 7 which provides a dashboard view and report generation facility.

Third party use: The CSB platform can enable a third party to do the audit on behalf of the user. The third party may be an IT provider or broker. The third party who monitors users system can also be provided a third party log in, which incorporates data monitoring, access, reporting on activities and monitoring direct to the third party.

For example, a medium size business may have an outsourced IT provider. They can be provided with a version of the third party CSB application that enables them to complete a compliance audit along with the company representative. The third party user can then be held accountable for their IT compliance checking via logging all work in the application. When notifications are sent, the IT provider is notified to update the system accordingly and then report this within the CSB application.

The IT provider's activities are then reported on within the dashboard and data monitoring reports.

The external reporting and checking unit 6 monitors this data, as well as all inputs to provide accurate scoring ongoing with all variables accounted for.

The Data Capture and Mining Unit 5 collects company data and external cyber risk and threat notifications. This allows for the provision of actuarial data for the prediction of potential claims. The Unit 5 is responsible for the data capture across the corporate IT systems and is used to collect data, map, collate and predict imminent threats and the likelihood of events.

The Unit 5 downloads external information on Industry types, company size, system infrastructure and third party applications. Over time it continually collects data sets as above. It also can include audit data and patch management data, including third party software.

The CSB Cyber Scoring Unit 4 attempts to analyse risks of company type and potential loss of data by taking into account specifics as above (as an example), matching this with external data such as cyber attacks on specific company types, equipment and applications.

The Unit 4 can include gamification principles such as comparing industry and business type scores regularly via notifications to entice users of the CSB Cyber App 7 to interact with the system to improve their score and regularly update their assessment.

The External Reporting and Checking Unit 6 provides a number of services, including a policy and procedure service, which provides access to industry approved policies. This section of the platform 1 will enable users to Q&A which will result in output documents that can be used to formulate external services. The Unit 6 can store the policies within the solution and download updates. This enables changes to be made and also allows for companies using the Cardinal system to attain and remain in full compliance with best practice.

Once the assessment is complete, the scoring unit 4 provides an overall CSB Cyber Score, which provides an overall measure of the company or organization's cyber security and compliance risk. The CSB Cyber Score provides a measure which can be utilised by third parties, for example, insurance providers, to set policies and premiums based on accurate and upto date assessment of cyber security risks. The CSB Cyber Score can be used by insurance underwriters to create meaningful actuarial data for cyber security risk, which allows insurers to predict risk, potential risk and potential claims with greater accuracy

The system 1 includes the CSB Cyber App 7 which can be a notification centre within the web based application as well as a stand-alone notification only app for iOS or other mobile operating platforms

The notification centre provides details of daily cyber threats and incoming reports from third parties within one location. The centre interacts with the ecosystem for cyber reporting bodies around the world, via external reporting and checking system 6. The notification system can be set up to report only relevant information to the particular business and the system requirements of that business. Examples can include patch notifications relevant to their audit of equipment and applications.

The mobile application can provide a staggered series of levels of potential actions for protection of the IT assets of the company to legitimately improve its CSB Cyber Score. The notification system will also notify users where they have failed to implement critical updates or regulatory requirements.

The App 7 can include a Dashboard report which is dependent on the services used by the user. An individual user will have access to the reports applicable to them. Where a user is an enterprise, the app will include user privilege, separate log ins and reports. The App 7 can also provide claims logging management for the users to log insurance claims.

External Reporting and Checking Unit 6: The Unit 6 includes reporting and checking for virtual centre compliance and regulation protocols for specific locations, such as state and federal laws.

Update insurance Disclosure: the system provides the ability for the user to give updates with the required mandatory disclosure to insurance providers where change has occurred. (where a user has a cyber security policy).

Breach Reporting: The Unit 6 provides Q&A for all incident reporting related to cyber incidents. Where applicable this data can be shared with third parties such as government organizations (e.g. Federal Police) for use to monitor cyber threats nationwide.

Cyber Scoring Unit 4: The cyber scoring algorithm is developed to provide an overall score for insurance purposes. The score provides a best practice benchmark to the world on industries that are cyber prepared. It also allows governments to set best practices with accurate risk assessments to minimize liability for businesses. The cyber score can also be used within third party applications and transferred where applicable.

For example, where an underwriter wants to utilise company cyber scores when a client applies for insurance policy, the cyber scoring unit can create a real time policy on the client's exact protection and coverage needs. As another example, a bank can incorporate the cyber score (via a system API) when a customer applies for merchant services (e.g. Payment handling) and may adjust its pricing and payment limits according to the level of cyber security demonstrated through the company's Cardinal Cyber Score.

Further Alternative CSB Embodiments

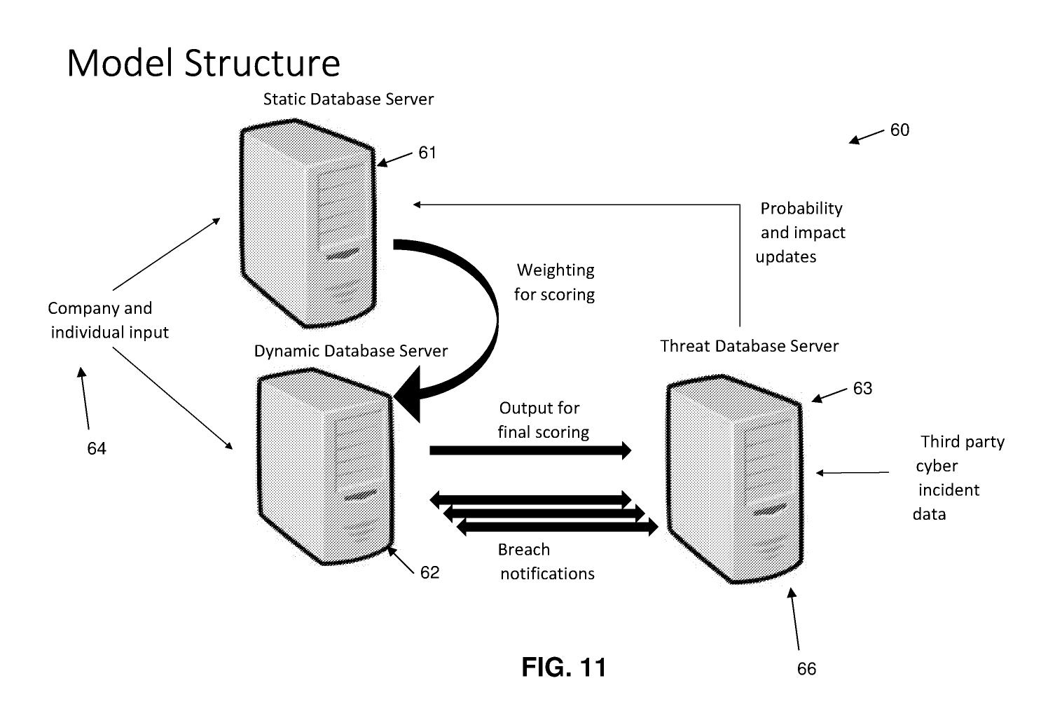

A number of alternative arrangements or architectures for implementing a CSB system in an organization environment are possible. For example, FIG. 11 illustrates one such alternative arrangement that uses a model 60 where three databases interact across an organization. Each of the databases can be separately located on a separate server or co-located. The database servers include a static data database server object 61, a dynamic data database server object 62 and a threat data database server object 63.

The servers 61, 62 received data in the form of company wide and individual inputs 64. The database 61 outputs weighting information 65 which is forwarded to dynamic database server object 62, combined with other information before output for final scoring by threat database server object 63. The treat database server object 63 receives external information including third party cyber incident data 66.

The information in server 61 relates more to the static information about a company, including general field of operation. The data in server 62 is related to more dynamic data that changes in real time.

Because the system captures data on a real time and ongoing basis, the CSB system is able to provide both an initial published Cyber Security Score, as well as an ongoing trending score. In many ways the trending score can be a more significant predictor of cyber security risk than the published score, as it is more accurately indicative future cyber security outcomes.

The static server 61 can store information such as: (a) details on the entity covered, including revenue size and industry; (b) an entity profile, including the online profile, public listing information and geographic spread, and other externally viable information. The company profile provides an initial probability for cyber exposure. The Industry provides a propensity to cyber attack derived from the threat server—this can be fed dynamically by external sources, and internal CSB user breach notifications. Over time these values are amended to provide likely weighting scores for status and profile of company.

In respect of the dynamic database server object 62, this server object is responsible for entity features such as systems and network compliance, in addition to individual staff profiles such as cyber types and past cyber experience. The information collected can include: company or entity infrastructure, systems and security set-up, and policies and governance interrogated directly through question clusters. Clusters contain independent questions which lead to dependent questions (triggered by specific answers) on a dynamic basis, with relationship between questions adjusted and updated through machine learning from outcomes of prior scoring activity. An entity score is then modified (positively or negatively) by the individual employee scores. (If none is available then this is weighted as an average return). The employee responses can be assessed against a psychodynamic model which maps personality types against likely propensity to reduce entity-level cyber threats or increase them. For example, staff with high attention to detail and commercially experience are unlikely to be taken in by phishing attacks. Individual scores can also be highly influenced by prior experience of cyber incidents and cyber threat training

The external threat database server object 63 stores information on the external ‘cyber weather’, including information of incident types, breaches, volume of incidents, focus of threats. Further information can be directed to cyber causality, which includes information on the likely impact of cyber attacks and the control effectiveness in controlling prior attacks.

This server can receive daily and real time updates of cyber incidents and breaches from external governmental and commercial agencies, receive real time updates of cyber breaches from a providers breach notification system, assesses probability of likely increase in incidence of cyber threats in specific industries, businesses, locations—based on static data, maintain causality tables of probability of cyber incidents arising as result of control (or lack of them) as well as relative impact of incidents as varied by key features (size of company, type of breach, governance implemented, etc), the causality tables can be updated through experience and machine learning.

The threat server also derives a final cyber score for each entity, using inputs from the static and dynamic data servers. These are available to an assessed company's staff together with highlighted areas of weakness, identified through cross-matching threat data with entity characteristics as shown through the scoring process.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1-25. (canceled)

26. A method of interactive computer monitoring of the cyber security of an organization, comprising the steps of:
providing members of the organization with an computer interface to a gamification engine, the gamification engine interacting with the member with a series of questions and other interactive activities, with the members answering the questions and performing interactive activities, and the gamification engine producing a relative score based on the members interaction;
ranking the members of the organization on their interactive responses relative to other responses, including providing a ranking score; and,
providing overall ranking score information to third party agencies as an indicator of the cyber security readiness of the organization.

27. The method of interactive computer monitoring of the cyber security of an organization according to claim 26, further comprising the step of providing a breach server for monitoring cyber security attacks and breaches on the organization, and contributing a breach score factor for adding to the ranking of members of the organization.

28. The method of interactive computer monitoring of the cyber security of an organization according to claim 26, further comprising the step of providing aggregation of groups of member scores in an organization to provide a group score information for outputting to management and external agencies.

29. The method of interactive computer monitoring of the cyber security of an organization according to claim 28, further comprising providing an overall aggregation of member scores for an entire organization.

30. The method of interactive computer monitoring of the cyber security of an organization according to claim 26, wherein said ranking step includes modifying the relative score based on scores measured for additional members of the organization.

31. The method of interactive computer monitoring of the cyber security of an organization according to claim 30, further comprising the step of providing an initial set of questions or tasks to produce an initial assessment and baseline score and updating the score over time.

32. The method of interactive computer monitoring of the cyber security of an organization according to claim 26, wherein the creation of said ranking score includes providing statistical sampling of cyber security risks faced by other organizations.

33. The method of interactive computer monitoring of the cyber security of an organization according to claim 26, further comprising the step of outputting status information on member compliance to an intermediary storage resource for review by third-party organizations for monitoring of organization compliance with operations.

34. The method of interactive computer monitoring of the cyber security of an organization according to claim 26, further comprising the step of providing a breach monitoring process for monitoring cyber security breaches of the organization and reporting the breaches, including providing a score factor for dealing with breaches.

35. The method of interactive computer monitoring of the cyber security of an organization according to claim 26, further comprising the step of providing an app or online interface for accessing user performance ratings and overall notifications of tasks to be performed to increase a users gamification score.

36. The method of interactive computer monitoring of the cyber security of an organization according to claim 26, further comprising the step of providing a series of interactive tasks for a member to perform to increase their ranking score and monitoring the completion of those tasks.

37. The method of interactive computer monitoring of the cyber security of an organization according to claim 26, further comprising the step of providing for a revision of the questions when an external policy is modified and updating the relative score when a revision is modified.

38. A method for increasing the cyber security of an organization, comprising the steps of:
providing an infrastructure/computer system for interacting with members of the organization to ask questions and provide tasks for dealing with compliance aspects of cyber security of the organization; and,
monitoring answers to the questions and providing a series of scores as a result; and providing a game that the users can play to increase the level of cyber security.

39. A system for determining the cyber security readiness of an organization or collection of interconnected computer resources, comprising;
an interface dashboard for providing overview facilities on the operations of the system;
a scoring unit for assigning a score to the security resistance of the collection of interconnected computer resources to external attacks;
an external reporting and checking module for accessing external computer networks for reporting security issues associated with the interconnected computer resources; and,
a data capture, storage and analysis module for storing events associated with the collection of computer resources.

40. The system for determining the cyber security readiness of an organization or collection of interconnected computer resources according to claim 39, wherein the scoring unit includes an interactive question module for providing interactive questions for determination of issues relevant to the security operation of the collection of interconnected computer resources.
